(19) United States
(12) Patent Application Publication
(10) Pub. No.: US 2026/0043731 A1
(43) Pub. Date: Feb. 12, 2026

(54) DETERMINING RELATIVE PERMEABILITY OF A POROUS MEDIUM

(71) Applicant: SHELL USA, INC., Houston, TX (US)

(72) Inventors: Steffen BERG, Amsterdam (NL); Ronny HOFMANN, Houston, TX (US); Bochao ZHAO, Houston, TX (US)

(21) Appl. No.: 19/099,234

(22) PCT Filed: Aug. 17, 2023
(86) PCT No.: PCT/US2023/072382

§ 371 Date: Jan. 28, 2025

Related U.S. Application Data
(60) Provisional application No. 63/400,562, filed on Aug. 24, 2022.

(30) Foreign Application Priority Data
Sep. 16, 2022 (EP) 22196135.2

(51) Int. Cl. G01N 15/08; G01N 15/0227

(52) U.S. Cl. CPC G01N 15/0826; G01N 15/0227

(57) ABSTRACT

A method for determining a relative permeability of a porous medium uses a segmented structural image generated from a 3D image to produce a pore-scale output from a pore-scale flow simulation. A Darcy-scale flow model is generated by simulating fluid flow on boundary conditions of the pore-scale flow simulation and an initial relative permeability model. The Darcy-scale output is compared to the pore-scale output to determine a degree of match. The initial relative permeability model is updated and the Darcy-scale simulation and inverse modeling steps are repeated until the degree of match falls within a pre-determined tolerance.

### FIELD OF THE INVENTION

The present disclosure relates to the field of fluid flow in porous media. In particular, the present disclosure relates to determining relative permeability of porous media.

### BACKGROUND OF THE INVENTION

Analytical and imaging techniques can help visualise fluid flow in porous media for a number of applications including, for example, without limitation, hydrology, contaminant hydrodynamics, petroleum engineering, carbon capture and sequestration, hydrogen storage, fuel cells, electrolysis, and conversion of CO₂ into base chemicals.

For example, in the face of a growing global energy consumption, with a need to reduce pressure on the environment, enhanced oil recovery (EOR) and carbon capture and sequestration (CCS) enable hydrocarbons to be produced in a more sustainable manner. Through EOR, more hydrocarbons can be sourced from a single well by injection of brine, polymers, or surfactants, thereby reducing the need for additional drilling. In CCS, carbon dioxide is re-injected into a reservoir so that it does not enter the atmosphere. Fluid flow and dispersion in rock also drives the process of geothermal heat extraction, which is another promising source of renewable energy. Meanwhile, seasonal storage of hydrogen underground is also of interest. Understanding fluid flow properties plays a key role in deployment of such technologies.

Numerous factors influence fluid flow, including, for example, fluid density and viscosity, interfacial tension, fluid flow rate, surface wettability and pore geometry. Laboratory tests for these factors require substantial time and are quite expensive. Further, the number of samples that may be processed is relatively limited due to the time and expense required to conduct each test.

In conventional processes, while the aim is to use actual fluids such as CO₂ and H₂, the common practice is that relative permeability are often experimentally measured with model fluids, such as decalin as oleic or non-wetting phase or nitrogen gas to represent the gas phase. The preferred method to experimentally measure relative permeability is the steady-state method which provides a wider accessible saturation range, is typically easier to interpret, and is more robust against displacement instabilities, as compared with other methods such as the unsteady-state method. However, the steady-state method requires injection of thousands of pore volumes of fluid at different fractional flow rates. For the case of CO₂ and H₂, that may pose significant technical challenges for experimental setup and handling of fluids, but also may suffer from reactions between dissolved CO₂ or H₂ and minerals. Further, it is challenging to measure capillary pressure and saturation for live fluids and gasses, for which reason these measurements are often conducted with specialized methods on twin samples.

Alternatively, an option is to consider the unsteady-state method which is better suited for handling the fluids of interest and operates generally at significantly reduced injection volumes than the steady-state method. Under specific operating conditions, the unsteady-state method allows simultaneous determination of relative permeability and capillary pressure-saturation functions under relevant operating conditions. Traditional interpretation methods for unsteady-state experiments are often based on analytical models. Although they have significantly improved to also capture the impact of the capillary end-effect, they still make often significant simplifications and, in many cases, do not integrate all the experimentally measured quantities, such as saturation profiles which can be obtained by in-situ X-ray saturation monitoring.

There is a need for providing information more quickly in order to make more timely decisions. Digital rock physics is a technology that has been developed to provide faster, more, and less expensive analysis of porous media. Digital rock physics utilizes digital images of formation rocks to simulate rock physics at the pore-scale and to predict properties of complex rocks. A major focus of Digital rock technology is to accurately simulate fluid flow behaviour within the pore space in order to predict petrophysical properties, for example permeability, of a sample.

Pore-scale flow simulation, based on an understanding of the dynamics of fluid displacement at the pore-scale, can facilitate computation of Darcy-scale flow parameters used as inputs, for example, in reservoir simulation.

One type of fluid flow simulator is based on the lattice-Boltzmann method (LBM). which simulates the collision and streaming of microscopic particles, and then evaluates the macroscopic pressure gradient and velocity, from which the permeability of a porous material can be estimated (Chen et al. “Lattice Boltzmann method for fluid flows” Annu Rev Fluid Mech 30:329-64; 1998). For example, Alpak et al. (“Prediction of fluid topology and relative permeability in imbibition in sandstone rock by direct numerical simulation” Advances in Water Resources 122:49-59; 2018 and “Direct simulation of pore-scale two-phase visco-capillary flow on large digital rock images using a phase-field lattice Boltzmann method on general-purpose graphics processing units” Computational Geosciences 23:849-880; 2019) describe an energy-based LBM (eLBM) that is a two-phase flow simulation system composed of three modules: forced drainage simulation module, forced imbibition simulation module, and a steady-state relative permeability computation module.

There is a need for improving the speed and accuracy of porous media parameters, while reducing the time and expense of computational resources.

### SUMMARY OF THE INVENTION

According to one aspect of the present invention, there is provided a method for determining a relative permeability of a porous medium, comprising the steps of: (a) providing a 3D image for a porous medium sample; (b) generating a segmented structural image from the 3D image to identify pore space and solid material; (c) simulating fluid flow on the segmented structural image with a pore-scale flow simulation to produce a pore-scale output; (d) selecting an initial relative permeability model; (e) generating a Darcy-scale flow model by simulating fluid flow based on boundary conditions of the pore-scale flow simulation using the initial relative permeability model to generate a Darcy-scale output; and (f) comparing the Darcy-scale output to the pore-scale output to determine a degree of match; and (g) updating the initial relative permeability model and repeating steps (e) to (g) until the degree of match falls within a pre-determined tolerance.

### BRIEF DESCRIPTION OF THE DRAWINGS

The method of the present invention will be better understood by referring to the following detailed description of preferred embodiments and the drawings referenced therein, in which:

FIG. 1 is schematic illustrating one embodiment of the method of the present invention;

FIGS. 2-5 are graphical illustrations of the pore-scale output in the Example of the present invention:

FIGS. 6 and 7 are graphical illustrations of the initial relative permeability model as compared to the matched relative permeability model after inverse modelling, in the Example of the present invention;

FIGS. 8-10 compare the match between the pore-scale output and Darcy-scale output in the Example of the present invention; and

FIG. 11 is a schematic representation of the computational domain discussed in the Example of the present invention.

### DETAILED DESCRIPTION OF THE INVENTION

The present invention provides a method for determining a relative permeability of a porous medium from a 3D image of the porous medium. The 3D image is segmented to generate a segmented structural image. A pore-scale flow simulation is conducted on the segmented structural image to produce a pore-scale output. A Darcy-scale flow model is then generated based on boundary conditions of the pore-scale flow simulation using an initial relative permeability model. The resulting Darcy-scale output is compared to the pore-scale output to determine a degree of match. The initial relative permeability model is updated. The Darcy-scale simulation and inverse modelling is repeated until the degree of match falls within a pre-determined tolerance.

Petrophysical properties of rock samples have been measured using Digital Rock technology using segmented structural images of the rock in 3 dimensions at pore-scale resolution. In general, pore-scale simulation of a 3D image of a porous medium requires high-powered computational resources with significant computational expense.

For reservoir simulation, Darcy-scale concepts are exclusively used with associated flow parameters, such as relative permeability and capillary pressure-saturation functions. In traditional workflows, these are determined in time-consuming and costly laboratory experiments, i.e., so-called “core flooding” experiments where fluids flow through cylindrical rock samples obtained from the field and relative permeability is obtained by interpreting production curve, pressure drop and saturation profiles of the experiment. Further, Berg et al. (“Sensitivity and Uncertainty Analysis for Parameterization of Multiphase Flow Models” Transport in Porous Media 140:27-57; 2021) describe an assisted history-matching workflow where experimental core flooding data are matched to the numerical solution of two-phase Darcy equations for extracting relative permeability functions.

In accordance with the present invention. Darcy-scale flow model interpretation is applied to pore-scale flow simulations. The present inventors have surprisingly discovered that predictions of relative permeability using the method of the present invention can be made accurately, timely, and with a lower demand on computational resources.

By “pore-scale”, we mean the length scale at which individual pores of the porous material are resolved. For porous rock, the pore-scale typically requires, for example, without limitation, a resolution of the 3D segmented image of 1-few micrometers. For example, the resolution limit for pore-scale simulation is discussed in Saxena et al (“Effect of image segmentation & voxel size on micro-CT computed effective transport & elastic properties” Marine and Petroleum Geology 86: 972-990: September 2017) incorporated by reference herein. For general porous media, the length scale is dependent on the actual porous media, and, therefore, can be significantly larger or smaller than 1 micrometer.

By “Darcy-scale”, we mean the scale at which the porous media is described by continuum mechanics approaches and respective parameters such as porosity, and permeability. For single-phase flow properties, that is typically the case at a length scale equal or larger than the representative elementary volume (for example, J. Bear, Dynamics of Fluids in Porous Media, Dover, 1988.) which for porous sandstone rock is typically between 2 and 4 mm. For general porous media, the length scale is dependent on the actual porous media and, therefore, can be significantly larger or smaller than 2-4 mm.

By “relative permeability model”, we mean relative permeability and capillary pressure-saturation function, and its parameterization with a functional form, such as (but not limited to) the Corey or LET model for relative permeability and the Skjaeveland model for capillary pressure, including the values of the parameters used in these models, or tabulated values with respective interpolation required for numerical calculations. In addition, or alternatively, the relative permeability model may comprise saturation end points, capillary end-effects, and combinations thereof.

Heretofore, those skilled in the art have distinctly separated the roles of pore-scale simulations and Darcy-scale flow simulations due to the length scales used in each respectively. The length scale at which this division occurs is called Representative Elementary Volume (REV). When the computational domain of the Digital Rock direct flow simulation is divided into grid blocks (e.g., 50 grid blocks), as used in conventional Darcy-scale inverse modelling, the length scale at each grid block is smaller than a REV. Accordingly, there is a common belief that Darcy-scale physics are not valid at pore-scale. Accordingly, while the whole computational domain of a pore-scale direct flow simulation might be a REV, the individual grid block is conventionally understood to be much smaller than a REV, and therefore not suitable for 2-phase Darcy equations used for the inverse modelling.

By better understanding the flow and distribution of a fluid across a porous medium, better decisions can be made with respect to hydrology, contaminant hydrodynamics, petroleum engineering, carbon capture and sequestration, hydrogen storage, fuel cells, electrolysis, and conversion of CO₂ into base chemicals.

For many modelling studies, for example for underground storage of carbon dioxide and hydrogen, it is important to have a consistent set of relative permeability and capillary pressure-saturation functions. Advantageously, both functions are determined in a single experiment using the same porous medium and fluid sample. However, experimental measurements typically have challenges. For the assessment of feasibility and the development of respective storage sites, for example in an underground formation of rock, for instance, in depleted oil and gas fields, or in saline aquifers, numerical models are employed. The need for such models ranges from estimating the storage capacity and the plume migration to assessing risks such as potential leakage or the stability of the displacement.

The relative permeability model is highly dependent on the wetting properties of the porous medium and the fluid that flows into the pore space of the rock, directly influencing parameters such as trapping of certain fluids. For example, supercritical CO₂ may not behave like a fully non-wetting fluid towards a hydrophilic medium but may have different wetting behaviour than other non-wetting fluids, such as n-decane. Further, H₂ has been found to have different wetting behaviour compared to N₂.

The present inventors have surprisingly discovered that cost- and time-effective unsteady-state type of pore-scale flow simulations can be used for simultaneously deriving a relative permeability model, within acceptable uncertainty ranges. By using a Darcy-scale flow simulation and comparing the Darcy-scale output to the pore-scale output and tuning the relative permeability model in-situ, the accuracy of the predictions is improved as compared with conventional methods.

The present invention accounts for capillary end-effects, and capillary effects in general that can have a large impact on the key parameters resulting from the interpretation, such as residual oil saturation. In conventional methods, steady-state simulations are typically used in an effort to capture capillary end-effects. Steady-state simulations are computationally very expensive because of long convergence times. In accordance with the present invention, inverse modelling for interpretation of unsteady-state pore-scale simulations, are much faster and computationally a lot less costly. In accordance with the method of the present invention, unsteady-state pore-scale simulation can be used to reliably extract a relative permeability model.

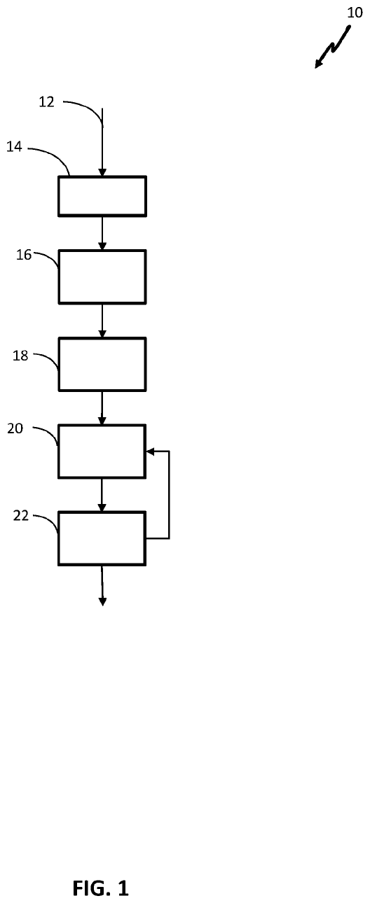

Referring now to FIG. 1, one embodiment of the method of the present invention 10 involves providing a 3D image 12 of a sample of porous media and generating a segmented structural image of the sample at step 14.

### 3D Images

The 3D image 12 is obtained utilizing pore-scale imaging technology. A 3D image 12 may be obtained by, for example, without limitation, by scanning electron microscopy (SEM), X-ray computed tomography, acoustic microscopy, magnetic resonance imaging, and the like. X-ray computed tomography includes, without limitation, X-ray micro-computed tomography (micro-CT) and X-ray nano-computed tomography (nano-CT). Most preferably, the 3D image 12 is obtained by micro-CT to provide sufficient field of view of the porous media to avoid edge pores distorting the overall porosity of the resulting image, as well as to reduce scanning time and computational requirements that higher resolution tomography (e.g., nano-CT) would require.

The 3D image 12 obtained by pore-scale imaging technology is comprised of a plurality of voxels, where the volume defined by each voxel represents a maximum resolution of the image. The resolution of the 3D image 12 should be selected to provide a voxel size at which the dominant pore throats for fluid flow in the porous medium are sufficiently resolved and at which a sufficient field of view is provided so as to be representative of the whole media for which a fluid transport property is to be analysed.

The resolution of the 3D image 12 may be selected based on the size of the sample, the relative average pore size, the time required for the imaging, and the computational power required to store and conduct further computational activity on the image data. For example, a pore-scale resolution for a micro-CT image may range, for example, from 0.1 μm³ to 30 μm³ per voxel. For sandstones, the micro-CT image is preferably produced at a resolution in a range from 1 μm³ to 25 μm³ per voxel, more preferably from 2.5 μm³ to 15 μm³ per voxel. For carbonates, the resolution of the micro-CT image is preferably produced at a resolution in a range from 0.5 μm³ to 20 μm³ per voxel, more preferably from 1 μm³ to 10 μm³ per voxel. For shales, the resolution of the micro-CT (or nano-CT) image is preferably produced at a resolution in a range from 0.1 μm³ to 10 μm³ per voxel, more preferably from 0.5 μm³ to 5 μm³ per voxel.

Where the porous medium of interest is a rock, the rock sample may be obtained from a formation for which the fluid transport properties are of interest. As an example, the rock may be a sandstone, a carbonate, a shale, and combinations thereof from a hydrocarbon-containing formation. Alternatively, the rock may be from a subsurface formation for which carbon sequestration is being considered. The rock may be obtained by conventional means for obtaining rock samples from a formation. In a preferred embodiment, a core sample of the rock is obtained by coring a portion of the formation from within a well in the formation, for example, a whole core or a sidewall core. Alternatively, a sample of the rock may be obtained from drill cuttings, preferably undisturbed drill cuttings, produced in drilling a borehole in the formation. The rock may be obtained from the same borehole as the electrical property measurement. Alternatively, the rock may be obtained from another borehole in the same field as the borehole for which the electrical property measurement was produced.

Alternatively, for fuel cells, electrolysis, and conversion of CO₂ into base chemicals, examples of porous media include, without limitation, ceramic and membranes.

Accordingly, the porous medium may be selected from rock, ceramics, membranes, and combinations thereof.

The porous medium sample should be of sufficient size to obtain a 3D image 12 of sufficient volume at the scale that the image is generated. In particular, the sample should be of sufficient size such that characteristics of the bulk of the sample predominate over the characteristics of the edges of the sample at the scale or field of view of the image to be generated.

In a preferred embodiment, the 3D image 12 may be pre-processed to reduce noise and image artefacts. Noise may be filtered from the acquired image by filtering using a local means filter to reduce noise. Imaging artefacts, predominant at the outer edges of the acquired image, may be reduced by processing the image while excluding the outer edges of the image.

### Segmentation

The 3D image 12 is subjected to segmentation 14 to identify pore space and solid material.

In one embodiment of the present invention, voxels of the 3D image 12 are segmented into voxels representing either pore space in the porous medium or solid material in the porous medium, thereby producing a binary image in which pore voxels have a value of zero and solid material voxels have a value of one (or vice versa). The 3D image 12 may be a grayscale image, and processing the voxels of the image to segment the image into voxels representing pore space or solid material may be effected by assigning a voxel a designation as pore space or as solid material based on a threshold, wherein voxels having an image intensity above the threshold may be assigned a value representing a pore (or solid material) and voxels having an image intensity below the threshold may be assigned a value representing solid material (or a pore). A threshold may be calculated using Otsu's method as described in Otsu (“A Threshold Selection Method from Gray-level Histogram” IEEE Trans. SMC 9:62-66; 1979), or other threshold calculation algorithms known in the art.

Segmentation algorithms are known to those skilled in the art. Preferably, the segmentation method is selected to identify pore space from solid matrix. Examples of segmentation methods are described in Otsu (“A Threshold Selection Method from Gray-level Histogram” IEEE Trans. SMC 9:62-66; 1979), Andra et al. (“Digital Rock Physics Benchmarks-Part II: Computing Effective Properties” Computers and Geosciences 50:33-43; 2013), Saxena et al. (“Effect of Image Segmentation & Voxel Size on Micro-CT Computed Effective Transport & Elastic Properties” Marine and Petroleum Geology 86:972-990; 2019), and Chuang et al. (“Fuzzy C-Means Clustering with Spatial Information for Image Segmentation” Comput. Med. Imaging Graph. 30:9-15; 2006). The desired selection of segmentation will be understood by those skilled in the art. Segmentation using segmentation algorithms is preferably conducted automatically using data processing systems.

In a preferred embodiment, the 3D image 12 is segmented at step 14 by the watershed-based segmentation algorithm (Beucher et al. “The morphological approach to segmentation: The watershed transformation” in: E. R. Dougherty (Ed.), Math. Morphol. Image Process., Marcel Dekker Inc., New York, 1993: pp. 433-481).

In another embodiment of the present invention, the 3D image 12 is segmented in step 14 using a multi-phase segmentation technique to correct for partial pores and/or porous materials.

### Pore-Scale Flow Simulation

In accordance with the present invention, fluid flow is simulated on the segmented structural image from step 14 with a pore-scale flow simulation 16.

Suitable types of pore-scale flow simulation 16 are known to those skilled in the art, including, without limitation, direct flow simulation which operates directly on a segmented pore-scale image to dynamically solve flow equations where viscous and capillary forces act simultaneously, quasi-static approaches which also operate directly on an image but are capillary-dominated, pore network modelling (both quasi-static and dynamic), machine-learning based approaches where pore-scale flow fields and pressure gradients are approximated, and combinations and hybrids thereof. Preferably, the pore-scale flow simulation 16 is a direct flow simulation.

Direct flow simulations include, for example, without limitation, finite difference methods, finite element methods, finite volume methods, and lattice Boltzmann methods. Several methods have been developed for simulating single- and two-phase flows at molecular, pore, and other meso scales. These methods include lattice gas and lattice Boltzmann models, Monte Carlo models, molecular dynamics, smoothed particle hydrodynamics, dissipative particle dynamics, and Eulerian computational fluid dynamics. The latter family of techniques includes a front-tracking method, a volume of fluid method, a level-set method, and a phase-field method.

In a preferred embodiment, fluid flow is simulated with an LBM simulator. Examples of LBM simulators include, without limitation, an energy-based LBM (eLBM) simulator and a multiple-relaxation-time (MRT) LBM simulator.

In accordance with the present invention, numerical modelling is used to simulate fluid flow at a scale where pores are discrete. Preferably, the fluid flow is multi-phase, for example 2-phase flow). More preferably, the multi-phase fluid flow is conducted with at least two immiscible fluid phases. Most preferably, the multi-phase flow is conducted with a wetting fluid and a non-wetting fluid. Preferably, the pore-scale flow simulation 16 is conducted at the continuum hydrodynamic scale with Navier-Stokes flow equations for 2-phase flow.

In pore-scale flow simulation 16, hydrodynamic flow equations are solved directly on the complex pore space in the segmented image from step 14. By performing the pore-scale flow simulation 16 directly on the segmented image, remeshing uncertainties are avoided. Unlike traditional pore network modelling techniques and morphological modelling approaches, capillary and viscous forces act concurrently in pore-scale flow simulations 16. Accordingly, both capillary- and viscous-dominated flows can be rigorously captured by pore-scale flow simulation 16. Further, pore-scale flow simulation enables the description of a wide range of flow regimes and simulation of a wide range of pore-scale dynamics, such as cooperative and/or nonlocal displacement processes.

In conventional methods, the pore-scale flow simulations are conducted using a steady-state approach, wherein wetting and non-wetting phases are co-injected at monotonically increasing (imbibition) or decreasing (drainage) fractional flow f_{w} where at each fractional flow, steady-state is achieved under constant pressure and constant average saturation. This can require several hundreds of injected pore volumes of fluid. This is time-consuming and computationally costly.

In accordance with the present invention, pore-scale flow simulations 16 are conducted using an unsteady-sate approach, wherein the number of required pore volume injections is an order of magnitude smaller. Conventional processes avoid the unsteady-state method because relative permeability predictions suffer from capillary end-effects and a high degree of uncertainty. Further, those skilled in the art understand that non-unique solutions are possible.

Boundary conditions of the pore-scale flow simulation include, without limitation, conditions relating to fluid types, fluid viscosities, interfacial tension, flow rates, ratios of fluids, pressures, temperatures, and combinations thereof.

In accordance with the present invention, pore-scale flow simulation 16 is conducted on the segmented structural image to determine a pore-scale output. The pore-scale output includes, without limitation, fluid distribution, fluid pressure distribution, total pressure drop of fluid phases over the simulated domain, fluid production curves, and/or spatial gradients and/or other properties related to fluid distribution and pressure, such as flow velocity. In step 18, a Darcy-scale flow model is generated by simulating fluid flow based on the boundary conditions of the pore-scale flow simulation using an initial relative permeability model. Preferably, the Darcy-scale flow simulation is performed for a plurality of predetermined fluid flow rates.

### Darcy-Scale Flow Model

The Darcy-scale flow model is generated at step 18. The Darcy-scale flow model may be 1D, 2D or 3D. In a preferred embodiment, the Darcy-scale model is 1D.

The governing equations for one-dimensional two-phase flow in homogeneous porous media are formulated in absence of gravity, to relate the Darcy velocity v (which is the flow rate q divided by the cross-sectional area A) to the pressure gradient

$$\frac{\partial p}{\partial x}$$

for a 1-dimensional flow in x-direction. The volumetric flux vₐ of fluid phase a, where a=w for a wetting fluid phase and a=n for a non-wetting fluid phase, is given by Eq. 1:

$${v}_{α} = - \frac{{k}_{r , α}}{{μ}_{α}} K \frac{\partial {p}_{α}}{\partial x} \qquad ( 1 )$$

where k_{r,α} is the relative permeability of phase a, K is the absolute permeability of the porous medium, μ_{α} is the viscosity of phase a, and p_{α} is the pressure of phase a.

The continuity equation (2) represents the conservation of mass where saturation changes over time t are related to the divergence of the flow:

$$ϕ \frac{\partial {S}_{α}}{\partial t} + \frac{\partial {v}_{α}}{\partial x} = 0 \qquad ( 2 )$$

where Sₐ is saturation of phase a, and

$$\frac{\partial }{\partial t}$$

is the time derivative.

Assumptions may include, for example, without limitation:
a constant total flux of wetting and non-wetting fluid phases, v_{T}=v_{w}+vₙ, for the flow of two incompressible fluids;
the sum of wetting and non-wetting phase saturation S_{w}+Sₙ=1; and
relative permeability and capillary pressure are functions of saturation only.

The set of equations is closed by relating the pressure difference between wetting and non-wetting phases to the capillary pressure in Eq. (3):

$${p}_{w} - {p}_{n} = {p}_{c} \qquad ( 3 )$$

Mobility is defined as

$${λ}_{α} = \frac{{k}_{r , α}}{{μ}_{α}}$$

for phase α, while the fractional flow is defined by Eq. (4)

$${f}_{w} = \frac{{λ}_{w}}{{λ}_{w} - {λ}_{n}} \qquad ( 4 )$$

Eq. (1)-(4) are combined in Eq. 5 which describes the evolution of saturation S_{w}(x, t) in space and time.

$$ϕ \frac{\partial {S}_{w}}{\partial t} + \frac{\partial }{\partial x} [ {f}_{w} {v}_{T} ] + \frac{\partial }{\partial x} [ {f}_{w} {λ}_{n} \frac{\partial {p}_{c}}{\partial x} ] = 0 \qquad ( 5 )$$

In the process of the present invention, Eq. Error! Reference source not found.) is solved numerically, yielding the production curve can be computed by integrating the saturation profile over the computational domain in x.

$$Q ( t ) = {\int }_{0}^{L} {S}_{w} ( x , t ) dx \qquad ( 6 )$$

The reduced or mobile saturation is defined in Eq. (7) where S_{w,c} is the irreducible wetting phase saturation and S_{n,r} is the irreducible non-wetting phase saturation. In the case of a hydrocarbon-bearing formation, for example, the wetting phase may be connate water, while the non-wetting phase may be residual oil.

$${S}_{red} = \frac{{S}_{w} - {S}_{w , c}}{1 - {S}_{w , c} - {S}_{n , r}} \qquad ( 7 )$$

Relative permeability and capillary pressure are parameterized using a suitable model For example, Corey (“The interrelation between gas and oil relative permeabilities” Prod. Monthly 19:1:38-41; 1954) expresses the relative permeability of wetting and non-wetting phases as a simple power law of reduced saturation S_{red} as described shown in Eqs. (8):

$${k}_{r , w} = {{k}_{r , w}^{0} ( {S}_{red} )}^{{n}_{w}} \qquad ( 8 )$$

$${k}_{r , n} = {{k}_{r , n}^{0} ( 1 - {S}_{red} )}^{{n}_{n}}$$

where

$${k}_{r , w}^{0} = {k}_{r , w} ( {S}_{n , r} ) and {k}_{r , n}^{0} = {k}_{r , n} ( {S}_{w , c} )$$

are the endpoint relative permeabilities of wetting and non-wetting phases at the irreducible saturation of the respective other phase, and n_{w} and nₙ are the power law “Corey” exponents. The Corey exponents define the curvedness of the relative permeability-saturation relationship.

Alternatively, the LET model (Lomeland et al. “A new versatile relative permeability correlation” International Symposium of the Society of Core Analysts, Toronto, Canada, 21-25 Aug. 2005, Paper SCA2005-032) provides more degrees of freedom, as compared to the Corey model, to describe relative permeability of wetting and non-wetting phases according to Eqs. (9):

$${k}_{r , w} = {k}_{r , w}^{0} \frac{{S}_{red}^{{L}_{w}^{n}}}{{S}_{red}^{{L}_{w}^{n}} - {{E}_{w}^{n} ( 1 - {S}_{red} )}^{{T}_{w}^{n}}} \qquad ( 9 )$$

$${k}_{r , n} = {k}_{r , n}^{0} \frac{{( 1 - {S}_{red} )}^{{L}_{w}^{n}}}{{( 1 - {S}_{red} )}^{{L}_{w}^{n}} + {E}_{w}^{n} {S}_{red}^{{T}_{w}^{n}}}$$

where the parameters

$${L}_{w}^{n} , {L}_{n}^{w} , {E}_{w}^{n} , {E}_{n}^{w} , {T}_{w}^{n} , and {T}_{n}^{w}$$

define the shape of kᵣ(S_{w}). In one embodiment of the present invention, relative permeability is parameterized using the LET model, but keeping E and T parameters fixed.

The capillary pressure-saturation function p_{c}(S_{w}) can be expressed, for example using the model from Skjaeveland et al. (“Capillary pressure correlation for mixed-wet reservoirs” SPE India Oil and Gas Conference and Exhibition, 17-19 Feb. 1998, New Delhi, India, SPE 39497), as shown in Eq. (10) where Sₙ=1−S_{w}, and c_{w}, cₙ, a_{w} and aₙ are adjustable parameters.

$${p}_{c} = \frac{{c}_{w}}{{( \frac{{S}_{w} - {S}_{w , c}}{1 - {S}_{w , c}} )}^{{a}_{w}}} + \frac{{c}_{n}}{{( \frac{{S}_{n} - {S}_{n , r}}{1 - {S}_{n , r}} )}^{{a}_{w}}} \qquad ( 10 )$$

Eq. (5) is solved numerically using an explicit finite difference scheme with time stepping control for two-phase incompressible flow with capillary pressure and gravity. In an embodiment of the present invention, this is implemented as native Python code and the computationally intensive components are compiled with a just-in-time compiler using a Python Numba package.

Other two-phase flow simulators with capillary pressure known to those skilled in the art can be used. As an example, these can be coupled with an inverse modelling framework in Python via wrappers.

The Darcy-scale flow model is generated by simulating fluid flow based on the boundary conditions of the pore-scale flow distribution and an initial relative permeability model in step 18. The initial relative permeability model may be selected, for example, without limitation, randomly, using a best-guess approach, using analytical approaches such as (but not limited to) the JBN method (Johnson et al. “Calculation of Relative Permeability from Displacement Experiments” Petroleum Transactions, AIME (1959)), directly inverting the 2-phase Darcy equation on sub-domains with limited saturation gradients to estimate the initial relative permeability-saturation function and the pressure differences between the fluid phases to estimate the initial capillary pressure-saturation function and combinations thereof. Other methods are known to those skilled in the art, for example, without limitation, methods that consider the impact of capillary pressure on relative permeability, as opposed to the JBN method which assumes capillary pressure to be zero.

Regardless of the method used, the more accurate the initial relative permeability model, the faster the convergence during the inverse modelling. For example, the present inventors found that using the JBN method to estimate the initial relative permeability model from the fluid phase pressures in the simulated domain, the inverse modelling converged in 20-100 iterations.

The Darcy-scale flow simulation may be performed with flow rate and other conditions consistent with the boundary conditions used in the pore-scale simulation. Preferably, the Darcy-scale flow simulation is performed for a plurality of predetermined fluid flow rates.

A Darcy-scale output 20 is compared to the pore-scale output to determine a degree of match. The comparison is done on the grounds of for instance (but not limited to) production curve, pressure drop over the domain for one or more fluid phases, fluid distribution (converted for comparison with the Darcy-scale simulation into saturation profiles), fluid phase pressures, phase flow velocities.

### Inverse Modelling

The Darcy-scale output 20 is then subjected to inverse modelling in step 22, which is an iterative inversion technique. An objective function is constructed for measuring the difference between the Darcy-scale output 20 and the pore-scale output from step 16. The relative permeability model is updated iteratively until a minimum is found for the objective function.

For example, the Darcy-scale output 20 may be compared and matched within a predetermined tolerance to a simulated production curve, pressure drop, and fluid saturation profiles from the pore-scale output by adjusting a relative permeability value and/or a capillary pressure value in the initial relative permeability model.

Inverse modelling 22 is performed with a two-phase flow simulator with capillarity whose numerical solution of 2-phase Darcy equations is matched with simulated data using either a gradient-based optimization method, such as Levenberg-Marquardt, or a Bayesian approach, such as Markov-chain Monte Carlo.

Preferably, a Levenberg-Marquardt algorithm can be used for performing a least-squares fit where the sum of the squared differences between data yᵢ is used to minimize an objective function based on Eq. (11):

$${χ}^{2} = {\sum }_{i} \frac{{( {y}_{i} - f ( {x}_{i} ) )}^{2}}{{ϵ}_{i}^{2}} \qquad ( 11 )$$

where yᵢ are data points at parameter value xᵢ and f(xᵢ) are the respective values computed by the model. χ² is then the sum of the squared mismatch between model and data, normalized by the uncertainty ϵᵢ which can be for instance the standard deviation in simulated data. In the case here, the data consists of production curve Q(t), pressure drop Δp, and saturation profiles S_{w}(x, t).

An objective function according to Eq. (12) incorporates production data Qᵢ, pressure drop Δp for water and oil phases, and saturation S_{w} of the reference data set (index ref) with weighting factors w_{Q}, wₚ and w_{S} for production data, pressure drop and saturation profiles, respectively

$${χ}^{2} = {w}_{Q} {\sum }_{{t}_{i}} \frac{{( {Q}_{nw , i} - {Q}_{nw , i}^{ref} )}^{2}}{δ {Q}_{i}^{2}} + {w}_{p} {\sum }_{{t}_{i}} \frac{{( Δ {p}_{i} - Δ {p}_{i}^{ref} )}^{2}}{δ {p}_{i}^{2}} + {w}_{S} {\sum }_{{x}_{i}} \frac{{( {S}_{w , i} - {S}_{w , i}^{ref} )}^{2}}{δ {S}_{w , i}^{2}} \qquad ( 12 )$$

An advantage of inverse modelling is that relative permeability can be obtained in an objective manner. The method produces overall less uncertainty by directly matching Darcy-scale output 20 to pore-scale output within a predetermined tolerance by iteratively updating a relative permeability model, instead of manually matching, such as in a steady-state experiment, each fractional flow profile and then fitting a relative permeability model afterwards.

### Example

The following non-limiting example of an embodiment of the method of the present invention as claimed herein are provided for illustrative purposes only.

A sub-volume of a cylindrical core sample was measured with a voxel size of 1.51 um to resolve the pore scale features of the sandstone. The sample was well-sorted with a grain size of fine to medium. This 3D image was segmented, and values for porosity (19%) and absolute permeability (470 mD) were obtained.

Unsteady-state two-phase flow pore-scale simulation were performed using an established lattice-Boltzmann approach. A total of nearly two pore volume of water was injected at a rate of 0.1 ml/min. Both water and oil phases were assumed to have equal density of 1 g/cm³ and equal viscosity of 1 cP. Table 1 summarizes the boundary conditions for the pore-scale flow simulation.

TABLE 1

| PROPERTY | SYMBOL | VALUE | |
|---|---|---|---|
| Porosity | φ | 0.19 | |
| Permeability | K | 470 | mD |
| Domain size (voxels) | | 650 × 650 × 1300 | |
| Resolution | | 1.51 | mm/voxel |
| Domain size (mm) | | 0.98 × 0.98 × 1.96 | |
| Initial water saturation | S_{w, i} | 0.09 | |
| Water Viscosity | μ_{w} | 1 | cP |
| Oil Viscosity | μₒ | 1 | cP |
| Injection Rate (average) | Qᵢ | 0.014 | cm³/min |
| Linear Flow Velocity (average) | vₗᵢₙ | 0.13 | cm/s |
| Interfacial Tension | σ | 25 | mN/m |
| Capillary Number | Ca | 5.3 × 10⁻⁵ | |
| Total Pore Volumes Injected | PVᵢₙⱼ | 1.7 | |
| Total time | tₜₒₜ | 2.52 | s |

| | |
|---|---|
| No. of time snapshots | 100 |

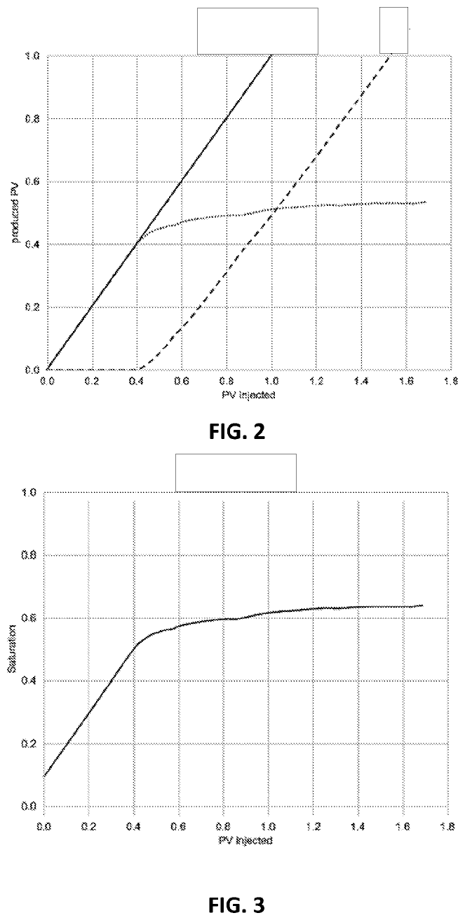

FIGS. 2-5 are graphical illustrations of the pore-scale output in this Example. Specifically, FIG. 2 illustrates the total fluid production (solid line), produced water (dashed line), and produced oil (dotted line), while FIG. 3 represents the average water saturation.

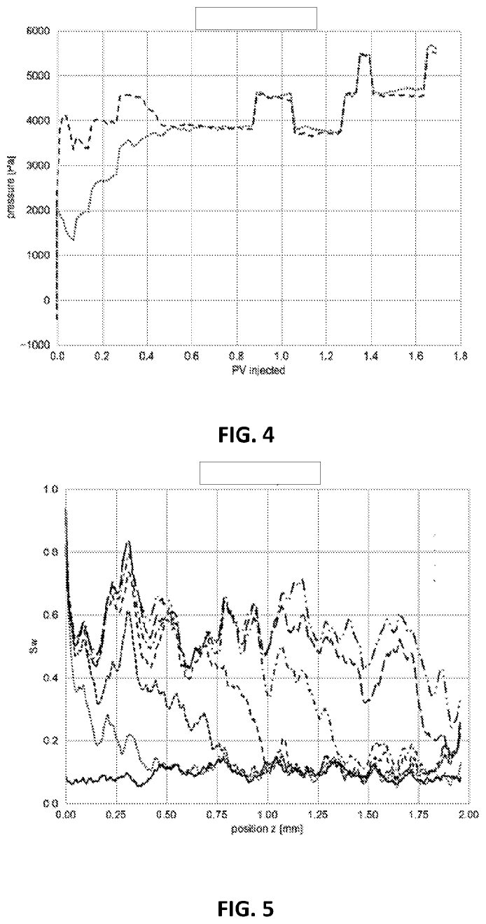

FIG. 4 illustrates the fluid pressure drop over the computational domain as a function of injected pore volume (PV), where the pressure drop for water and oil are depicted by dashed and dotted lines, respectively. FIG. 4 also shows the capillary pressure at the outlet as a function of injected PV.

FIG. 5 illustrates saturation profiles along the direction of injection (z), which is the direction in which the pressure gradient is applied. The different lines represent the saturation profile over time are listed in Table 2:

TABLE 2

| Time (seconds) | Line Style |
|---|---|
| 0.03 | Solid |
| 0.13 | Round dot |
| 0.25 | Square dot |
| 0.38 | Dash |
| 0.50 | Dash dot |
| 0.63 | Long Dash |
| 0.76 | Long Dash dot dot |

As noted in Table 1, the dimensions of the pore-scale simulation domain were 0.98 mm×0.98 mm×1.96 mm. For atypical sandstone having the porosity and permeability of Table 1, a REV would be in a range of from 2 to 4 mm. As a consequence, in the 1D property profiles in flow direction (z), it was expected that a reflection of the discrete pore—grain structure would not be fully averaged out at that scale. This largely explains the significant variations of saturation S_{w}(z), pressure p_{w,o}(z), capillary pressure p_{z}(S_{w}) visible in FIGS. 2-5 due to the pore-scale variation.

This variation explains why those skilled in the an have conventionally understood that the pore-scale variation therefore implies that a pore-scale output is still pore-scale because the computational domain size is close to the size of a REV. The present inventors have recognized that the pore-scale variations indeed influence the Darcy-scale properties. And, therefore, they have surprisingly discovered a method for Darcy-scale physics that captures pore-scale variations, even though the pore-scale variations are not visible in the Darcy-scale computational domain.

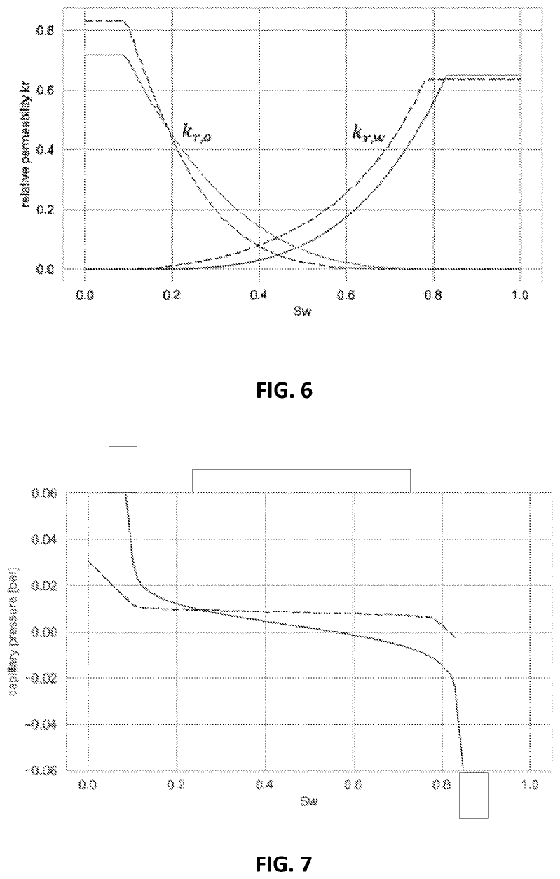

A ground-truth data set was generated starting with defining a set of relative permeability and capillary pressure-saturation functions. For the relative permeability and capillary pressure relations. Corey and Skjaeveland models were used, respectively. Then respective production curve, pressure drop, and saturation profiles were computed numerically by solving the Darcy-scale flow model. The Darcy-scale output was then matched to the pore-scale output by inverse modelling. The Darcy-scale output and inverse modelling match is depicted graphically in FIGS. 6-10.

In FIGS. 6 and 7, the initial relative permeability model is depicted in solid lines. Specifically, FIG. 6 shows the initial (solid lines) relative permeability of water k_{r,w}(S_{w}) and the initial relative permeability of oil k_{r,o}(S_{w}) as functions of fluid saturation. FIG. 7 shows the initial (solid line) capillary pressure p_{c}(S_{w}), as a function of fluid saturation. The dashed lines in FIGS. 6 and 7 represent the matched relative permeability model as a function of saturation after inverse modelling.

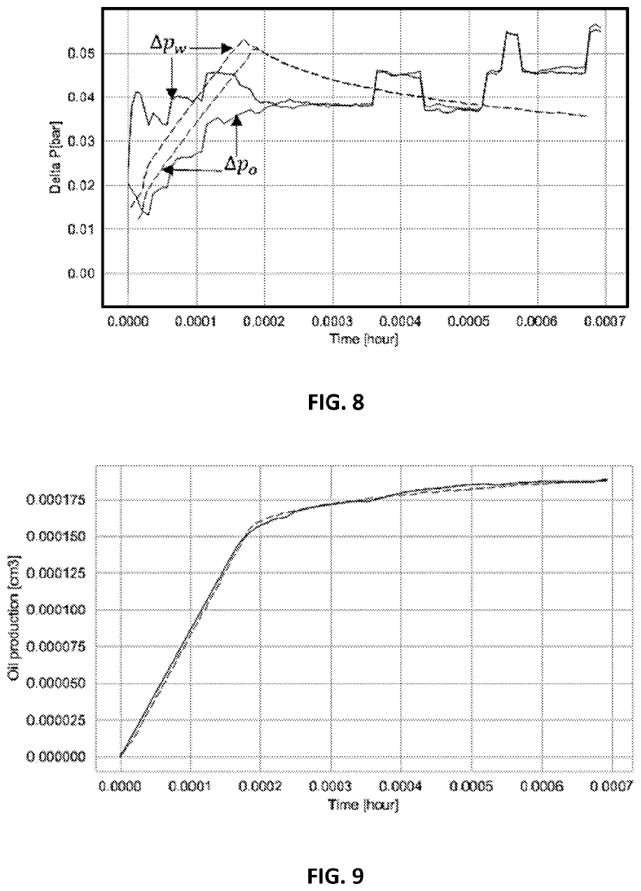

FIGS. 8-10 show the match between the pore-scale output (solid lines) and Darcy-scale output (dashed lines). FIG. 8 illustrates the matches for fluid pressure drop as a function of time, while FIG. 9 shows the match for oil production as a function of time.

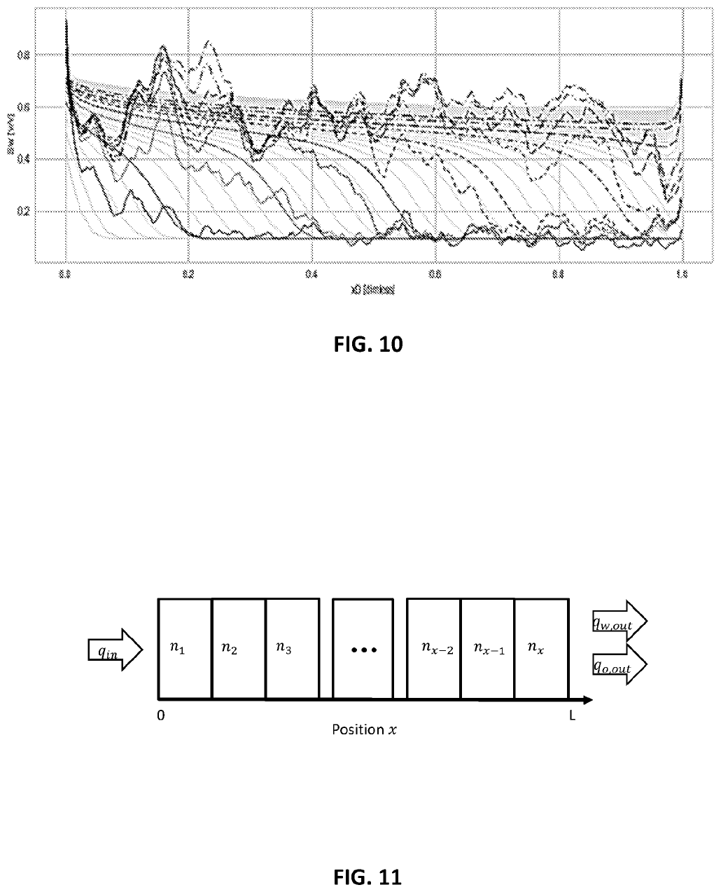

FIG. 10 illustrates the match of saturation profiles for pore-scale output and Darcy-scale output along the direction of injection (z). In FIG. 10, the Darcy-scale output is the smoother set of curves. The different lines represent the saturation profile over time in are listed in Table 3:

TABLE 3

| Time (seconds) | Line Style |
|---|---|
| 0.08 | Solid |
| 0.21 | Round dot |
| 0.34 | Square dot |
| 0.47 | Dash |
| 0.62 | Dash dot |
| 0.75 | Long Dash |
| 0.99 | Long Dash dot dot |
| 1.22 | Long Dash dot |

A numerical flow model and relative permeability and capillary pressure parameterizations were solved numerically with a 1D native Python code accelerated with the Numba just-in-time compiler.

The numerical solver was a 1D explicit finite difference scheme with time stepping control. It handled two-phase incompressible flow with capillarity and gravity in unidirectional flow, i.e., no counter-current imbibition.

FIG. 11 is a schematic representation of the computational domain. A 1D linear grid had nₓ grid blocks (where nₓ=50) in x direction over the sample length L. At the inlet, the water phase was injected at flow rate qᵢₙ. For the grid blocks in the computational domain, the respective flow parameters (porosity ϕ, permeability K, relative permeability k_{r,α}(S_{w}) and capillary pressure p_{c}(S_{w}) saturation functions) were defined, together with the initial conditions for saturation (S_{w,i}). A constant flow boundary condition was applied at the inlet. A constant pressure was applied at the outlet. In addition, a capillary pressure p_{c}=0 boundary condition was applied.

While the embodiments are described with reference to various implementations and exploitations, it will be understood that these embodiments are illustrative and that the scope of the inventive subject matter is not limited to them. Many variations, modifications, additions and improvements are possible. Various combinations of the techniques provided herein may be used.

1. A method for determining a relative permeability of a porous medium, comprising the steps of:
(a) providing a 3D image for a porous medium sample;
(b) generating a segmented structural image from the 3D image to identify pore space and solid material;
(c) simulating fluid flow on the segmented structural image with a pore-scale flow simulation to produce a pore-scale output:
(d) selecting an initial relative permeability model;
(e) generating a Darcy-scale flow model by simulating fluid flow based on boundary conditions of the pore-scale flow simulation using the initial relative permeability model to generate a Darcy-scale output; and
(f) comparing the Darcy-scale output to the pore-scale output to determine a degree of match; and
(g) updating the initial relative permeability model and repeating steps (e) to (g) until the degree of match falls within a pre-determined tolerance.

2. The method of claim 1, wherein the pore-scale fluid flow simulation of step (c) is conducted on a multi-phase fluid flow.

3. The method of claim 2, wherein the multi-phase fluid flow is conducted with at least two immiscible fluid phases.

4. The method of claim 2, wherein the multi-phase fluid flow comprises a wetting fluid and non-wetting fluid.

5. The method of claim 1, wherein the pore-scale fluid flow simulation is ID.

6. The method of claim 1, wherein the pore-scale fluid flow simulation is based on a lattice Boltzmann method.

7. The method of claim 1, wherein the pore-scale output comprises one or more of fluid distribution, fluid pressure drop, fluid production curves, gradients, and combinations thereof.

8. The method of claim 1, wherein the boundary conditions of the pore-scale flow simulation comprises conditions relating to fluid types, flow rates, pressures, temperatures, viscosities, and combinations thereof.

9. The method of claim 1, wherein the Darcy-scale flow model is generated by simulating fluid flow for a plurality of fluid flow rates.

10. The method of claim 1, wherein the porous medium is selected from the group consisting of rock, ceramics, membranes, and combinations thereof.

11. The method of claim 1, wherein the segmented structural image is generated by segmenting the 3D image into voxels representing pore space in the porous medium and voxels representing solid material in the porous medium.

12. The method of claim 1, wherein the segmented structural image is segmented by a multiphase segmentation technique.

13. The method of claim 1, wherein the 3D image of the rock is obtained by X-ray computed tomography.

14. The method of claim 1, wherein the relative permeability model comprises saturation end points, capillary end-effects, and combinations thereof.

15. The method of claim 1, further comprising the step of using the updated relative permeability for making a decision with respect to recovery of hydrocarbons from the subterranean formation.

16. The method of claim 1, further comprising the step of using the updated relative permeability for making a decision with respect to carbon capture and sequestration in the subsurface formation.

17. The method of claim 1, further comprising the step of using the updated relative permeability for making a decision with respect to a geothermal heat extraction process.
